(19) United States
(12) Patent Application Publication
(10) Pub. No.: US 2026/0371190 A1
(43) Pub. Date: Nov. 19, 2026

(54) CROSS HO SCHEME RECOVERY BETWEEN CHO AND (C)LTM

(71) Applicant: QUALCOMM Incorporated, San Diego, CA (US)

(72) Inventors: Doohyun SUNG, Basking Ridge, NJ (US); Ozcan OZTURK, San Diego, CA (US); Shankar KRISHNAN, Poway, CA (US); Jelena DAMNJANOVIC, Del Mar, CA (US); Prasada Veera Reddy KADIRI, San Diego, CA (US)

(21) Appl. No.: 19/673,823

(22) Filed: May 11, 2026

Related U.S. Application Data
(60) Provisional application No. 63/805,823, filed on May 14, 2025.

(51) Int. Cl. H04W 36/00; H04W 36/08; H04W 36/36

(52) U.S. Cl. CPC H04W 36/0079; H04W 36/08; H04W 36/362

(57) ABSTRACT

Aspects presented herein relate to methods and devices for wireless communication including an apparatus, e.g., a UE. The apparatus may obtain an indication of a failure of a first handover process including a first candidate cell or a second handover process including a second candidate cell. The apparatus may also perform a first recovery procedure for the failure of the first handover process or a second recovery procedure for the failure of the second handover process.

### CROSS REFERENCE TO RELATED APPLICATION(S)

This application claims the benefit of and priority to U.S. Provisional Application Ser. No. 63/805,823, entitled “CROSS HO SCHEME RECOVERY BETWEEN CHO AND (C)LTM” and filed on May 14, 2025, which is expressly incorporated by reference herein in its entirety.

### TECHNICAL FIELD

The present disclosure relates generally to communication systems and, more particularly, to mobility failure recovery mechanisms in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 6G, which is an enhancement of 5G New Radio (NR) and is a part of a continuous mobile broadband evolution promulgated by Third Generation Partnership Project (3GPP) to meet new requirements associated with latency, reliability, security, scalability (e.g., with Internet of Things (IoT)), capacity, location services, energy efficiency, artificial intelligence (AI) integration, and other requirements. Some aspects of 6G may be based on the 5G NR and 4G Long Term Evolution (LTE). There exists a need for further improvements in 6G/5G technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to obtain an indication of a failure of a first handover process including a first candidate cell or a second handover process including a second candidate cell; and perform a first recovery procedure for the failure of the first handover process or a second recovery procedure for the failure of the second handover process.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to transmit, to a UE, an indication of a configuration for at least one of a first recovery procedure for a failure of a first handover process including a first candidate cell and a second recovery procedure for a failure of a second handover process including a second candidate cell; and receive, from the UE, an indication of a performance of the first recovery procedure for the failure of the first handover process or the second recovery procedure for the failure of the second handover process.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a cell configuration for lower-layer-triggered mobility (LTM) and radio resource control (RRC) handover.

FIG. 5 is a diagram illustrating an example of a cross handover scheme recovery method in accordance with various aspects of the present disclosure.

FIG. 6 is a communication flow diagram illustrating example communications between a UE and a base station in accordance with one or more techniques of this disclosure.

FIG. 7 is a flowchart of a method of wireless communication in accordance with one or more techniques of this disclosure.

FIG. 8 is a flowchart of a method of wireless communication in accordance with one or more techniques of this disclosure.

FIG. 9 is a flowchart of a method of wireless communication in accordance with one or more techniques of this disclosure.

FIG. 10 is a diagram illustrating an example of a hardware implementation for an example apparatus and/or network entity in accordance with one or more techniques of this disclosure.

FIG. 11 is a diagram illustrating an example of a hardware implementation for an example network entity in accordance with one or more techniques of this disclosure.

### DETAILED DESCRIPTION

In wireless communication, a user equipment (UE) may transition its connection from one cell to another cell to maintain continuous connectivity, for example, due to signal quality degradation in the currently connected cell caused by fluctuating network conditions or UE mobility. This process is referred to as a handover process. In some examples, the handover process may involve radio resource control (RRC) signaling between the UE and the involved cells. In other examples, the handover process may be triggered based on events or conditions detected at lower layers of the communication protocol stack, such as the physical layer (layer 1 or L1) or the data link layer (layer 2 or L2), without involving higher-layer signaling such as RRC signaling. For ease of description, in this application, a handover process triggered at the lower layer (e.g., L1 or L2) is referred to as lower-layer-triggered mobility (LTM), while the term “handover process,” without explicitly specifying the signaling layers involved, is used to refer to a handover that involves higher-layer signaling. In some scenarios, a cell transition (e.g., a handover or LTM) may fail to complete successfully. In such cases, the UE may restore connectivity by connecting to a candidate recovery cell, a process referred to as handover failure recovery or LTM failure recovery, depending on the type of mobility event. However, current recovery mechanisms are limited in that LTM failure recovery selects from a restricted set of LTM candidate cells (e.g., those associated with the same central unit (CU) as the serving cell or the failed target cell), while high-layer handover failure recovery selects from a set of higher-layer handover candidate cells different from the set of LTM candidate cells. These limitations prevent recovery across different mobility types, such as recovering from an LTM failure using a handover candidate cell, or from a handover failure using an LTM candidate cell, which reduces mobility reliability and increases recovery latency. Example aspects presented herein provide methods and apparatus that enable failure recovery across different mobility types, such as between handover (including conditional handover (CHO)) and LTM (including conditional LTM (CLTM)).

Various aspects relate generally to wireless communication. Some aspects more specifically relate to mobility failure recovery mechanisms in wireless communication. In some examples, a UE obtains an indication of a failure of a first handover process including a first candidate cell or a second handover process including a second candidate cell. The UE then performs a first recovery procedure for the failure of the first handover process or a second recovery procedure for the failure of the second handover process. In some examples, the first handover process may be a handover (HO) process, a conditional HO (CHO) process, or a conditional primary secondary cell (PScell) change (CPC) process, and the second handover process may be an LTM process or a CLTM process. In some examples, the UE may select the first candidate cell for the first handover process or the second candidate cell for the second handover process. In some examples, the UE may initiate performance of the first recovery procedure for the failure of the first handover process or the second recovery procedure for the failure of the second handover process.

Particular aspects of the subject matter described in this disclosure can be implemented to realize one or more of the following potential advantages. In some examples, by enabling recovery from LTM or CLTM failure to CHO/CPC candidate cells (and vice versa), the described techniques may be used to reduce the handover recovery latency and avoid the need for the full RRC re-establishment, thereby improving handover reliability and reducing recovery latency. In some examples, by allowing the UE to evaluate both CHO and CLTM candidate cells with configurable weighting and selection criteria, the described techniques may help to prioritize recovery paths that are more reliable or time-sensitive based on real-time network conditions or ongoing mobility events, thereby enhancing robustness and service continuity during failure scenarios. In some examples, by enabling early triggering of LTM/CLTM recovery, the described techniques may be used to proactively prevent service disruption based on predictive modeling, historical data, or network-configured thresholds, thereby further enhancing communication reliability.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 6G systems, 5G NR systems, or other communication systems, may be arranged in multiple manners with various components or constituent parts. As an example, in a wireless communication network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, 6G NB, 6G RAN, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

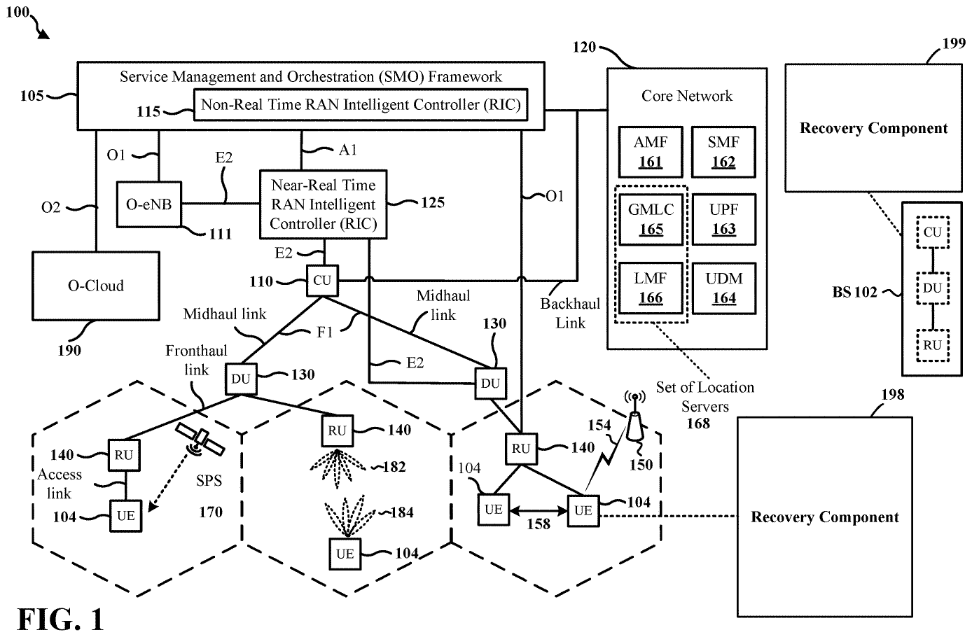

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. As an example, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. An operating band for these mid-band frequencies may have the frequency range designation FR3 (7.125 GHz-24.25 GHz), for example. Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation, or other wireless communication operation, beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the recovery component 198 that is configured to select a first candidate cell for a first handover process or a second candidate cell for a second handover process. Recovery component 198 may also be configured to apply, prior to selection of the first candidate cell, a set of first weights to at least one first candidate cell in a set of first candidate cells; and apply, prior to selection of the second candidate cell, a set of second weights to at least one second candidate cell in a set of second candidate cells. Recovery component 198 may also be configured to receive, from a network node, an indication of a configuration for at least one of a first recovery procedure or a second recovery procedure. Recovery component 198 may also be configured to obtain an indication of a failure of a first handover process including a first candidate cell or a second handover process including a second candidate cell. Recovery component 198 may also be configured to initiate, at the UE, performance of a first recovery procedure for the failure of the first handover process or a second recovery procedure for the failure of the second handover process. Recovery component 198 may also be configured to perform a first recovery procedure for the failure of the first handover process or a second recovery procedure for the failure of the second handover process. Recovery component 198 may also be configured to transmit an indication of performance of the first recovery procedure for the failure of the first handover process or the second recovery procedure for the failure of the second handover process. In certain aspects, the base station 102 may include the recovery component 199. The recovery component 199 may be configured to transmit, to a UE, an indication of a configuration for at least one of a first recovery procedure for a failure of a first handover process including a first candidate cell and a second recovery procedure for a failure of a second handover process including a second candidate cell; and receive, from the UE, an indication of a performance of the first recovery procedure for the failure of the first handover process or the second recovery procedure for the failure of the second handover process. Although the following description may give examples based on 5G NR to illustrate concepts relating to wireless communication, the concepts described herein may be applicable to other similar areas, such as LTE, LTE-A, CDMA, GSM, 6G and other wireless technologies.

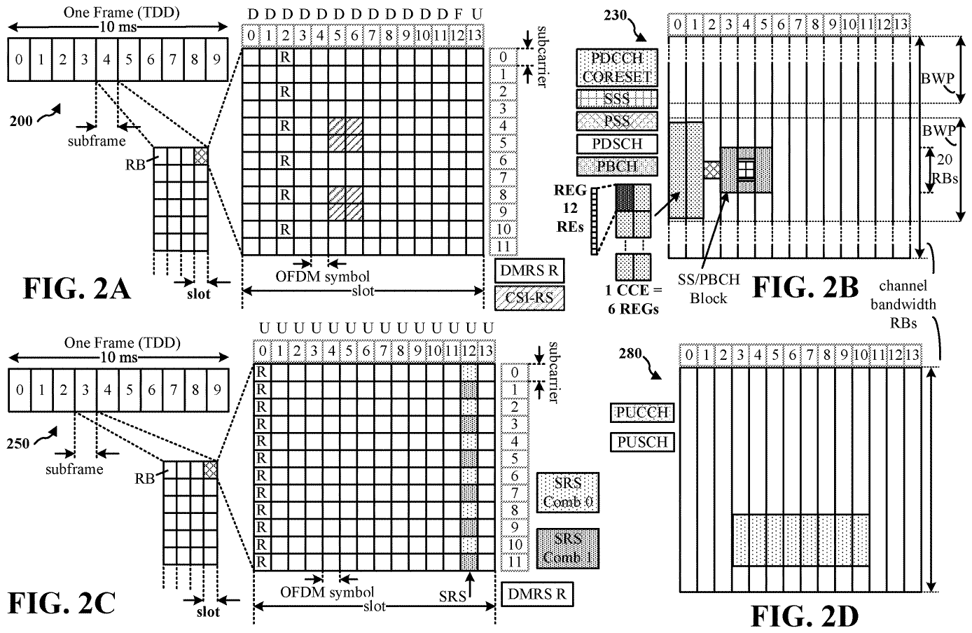

FIG. 2A is a diagram 200 illustrating an example of a first subframe within a frame structure. FIG. 2B is a diagram 230 illustrating an example of DL channels within a subframe. FIG. 2C is a diagram 250 illustrating an example of a second subframe within a frame structure. FIG. 2D is a diagram 280 illustrating an example of UL channels within a subframe. The examples in FIGS. 2A-2D show example aspects of a frame structure based on 5G NR to illustrate the concept of a frame structure and wireless communication based on a frame structure. Various aspects described in connection with FIGS. 2A-2D may also be used in connection with other wireless communication technologies, such as 6G among other examples. The frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

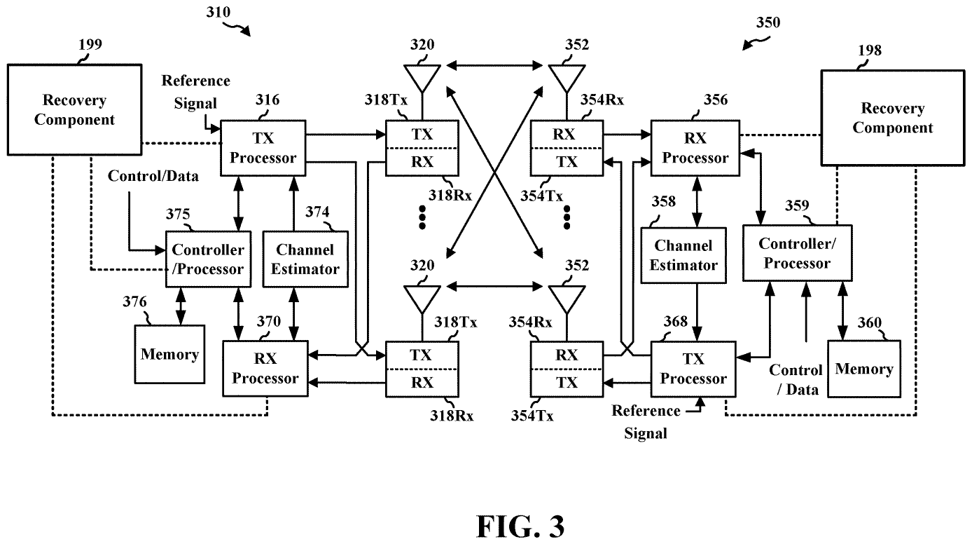

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate mapping matching, onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the recovery component 198 of FIG. 1.

At least one of the TX processor 316, the RX processor 370, and the controller/processor 375 may be configured to perform aspects in connection with the recovery component 199 of FIG. 1.

In wireless communication, a UE may transition its connection from one cell to another cell to maintain continuous connectivity, for example, due to signal quality degradation in the currently connected cell caused by fluctuating network conditions or UE mobility. This process is referred to as a handover process. In some examples, the handover process may involve RRC signaling between the UE and the involved cells. In other examples, the handover process may be triggered based on events or conditions detected at lower layers of the communication protocol stack, such as the physical layer (layer 1 or L1) or the data link layer (layer 2 or L2), without involving higher-layer signaling such as RRC signaling. For ease of description, in this application, a handover process triggered at the lower layer (e.g., L1 or L2) is referred to as LTM, while the term “handover process,” without explicitly specifying the signaling layers involved, is used to refer to a handover that involves higher-layer signaling.

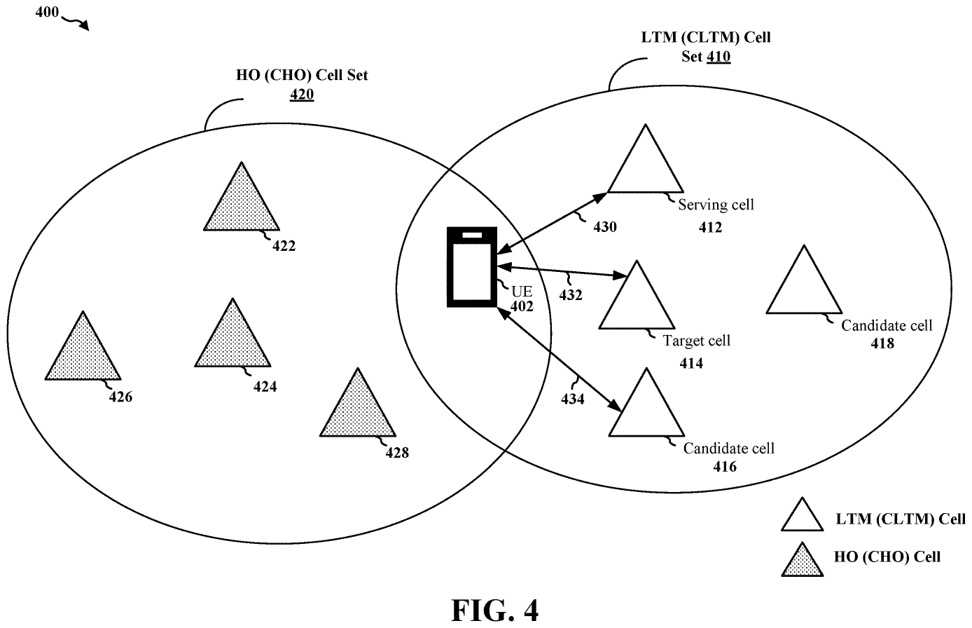

FIG. 4 is a diagram 400 illustrating an example of a cell configuration for LTM and RRC handover. As shown in FIG. 4, a UE 402 may be configured with an LTM (or CLTM) cell set 410. The LTM (or CLTM) cell set 410 may include one or more cells, including a serving cell 412 connected to the UE 402 (e.g., via 430), a target cell 414, and one or more candidate cells, such as candidate cells 416, 418. When the UE 402 performs an LTM, for example, when the signal quality from the serving cell 412 has degraded, the UE 402 may transition its connection from the serving cell 412 to another cell, such as the target cell 414 (e.g., via 432) to maintain continuous connectivity.

Similarly, the UE 402 may be configured with an HO (or CHO) cell set 420. The HO (or CHO) cell set 420 may include one or more cells, including cells 422, 424, 426, 428.

In some scenarios, a cell transition (e.g., a handover or LTM) may fail to complete successfully, for example, when the target cell (e.g., the cell to which the UE intends to transition) becomes unavailable during the process due to signal blockage or other environmental factors. In such cases, the UE may restore connectivity by connecting to a candidate recovery cell (e.g., candidate cell 416, 418 for LTM, or candidate cell 426, 428 for RRC handover). This recovery process is referred to as handover failure recovery or LTM failure recovery, depending on the type of mobility event. For example, following an intra-CU LTM failure, a UE may select an intra-CU LTM candidate cell (e.g., an LTM candidate cell associated with the same CU as the current serving cell), such as candidate cell 416 (e.g., via 434), as part of the recovery procedure. However, current recovery mechanisms are limited in that LTM failure recovery selects from a restricted set of LTM candidate cells (e.g., those associated with the same CU as the serving cell or the failed target cell), and handover failure recovery selects from a set of handover candidate cells (e.g., cell 426, 428) that is different from the set of LTM candidate cells. For example, the LTM failure recovery is constrained to intra-CU candidate cells, such as those associated with the same CU as the serving cell, or in some examples, to selected inter-CU candidate cells associated with the same CU as the target cell (i.e., allowing intra-CU recovery with respect to the target cell). This restriction exists because, upon receiving the LTM cell switch command (CSC) via a medium access control (MAC)-control element (MAC-CE), the UE may re-establish the packet data convergence protocol (PDCP) layer, and the security parameters are available for the target cell within the same CU. When the UE is not able to complete the LTM failure recovery (e.g., due to limited availability of suitable LTM candidate cells), the UE may have to go through an RRC re-establishment process to restore connectivity.

These limitations prevent recovery across different mobility types, such as recovering from an LTM failure using a handover candidate cell (e.g., cell in HO (or CHO) cell set 420), or from a handover failure using an LTM candidate cell (e.g., cell in LTM (or CLTM) cell set 410), which reduces mobility reliability and increases recovery latency. Example aspects presented herein provide methods and apparatus for a cross handover scheme recovery mechanism that reduces recovery latency by allowing LTM (or CLTM) failure recovery to handover (or CHO) candidate cells, and vice versa (e.g., enabling CHO recovery to an LTM or CLTM candidate cell). This cross-scheme recovery approach eliminates the need for an RRC re-establishment process and allows the UE to recover from LTM or CLTM failure by transitioning to inter-CU CHO candidates, or from CHO or condition PScell change (CPC) failure by transitioning to LTM candidate cells. As a result, this approach improves handover robustness and reduces service interruption.

In some aspects, both CHO (or CPC) and LTM (or CLTM) may be configured at the UE. In such cases, if a CHO/CPC or LTM (or CLTM) failure occurs, for example, due to the expiration of a timer (e.g., a T304 timer), a radio link failure (RLF), or a secondary cell group (SCG) failure occurring before the execution of the CHO/CPC or LTM (or CLTM), the UE may perform the failure recovery by using an alternative handover (HO) scheme to one of its configured candidate cells. For example, when an LTM or CLTM failure occurs, the UE may perform failure recovery using a CHO recovery scheme (e.g., using a CHO or CPC candidate cell). On the other hand, when a CHO (or CPC) failure occurs, the UE may perform failure recovery using an LTM or CLTM recovery scheme (e.g., using an LTM or CLTM candidate cell).

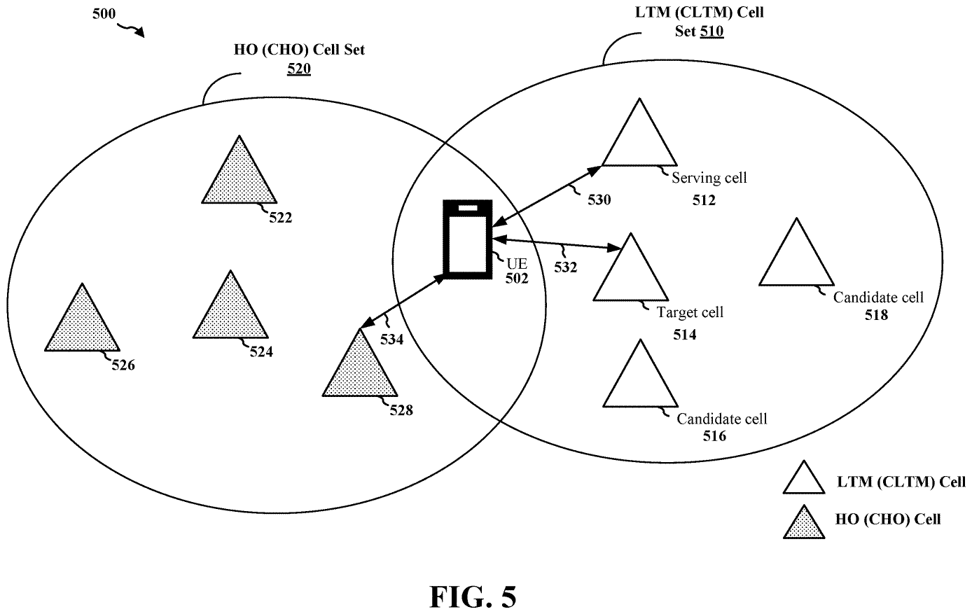

FIG. 5 is a diagram 500 illustrating an example of a cross handover scheme recovery method in accordance with various aspects of the present disclosure. As shown in FIG. 5, a UE 502 may be configured with an LTM (or CLTM) cell set 510. The LTM (or CLTM) cell set 510 may include one or more cells, including a serving cell 512 connected to the UE 502 (e.g., via 530), a target cell 514, and one or more candidate cells, such as candidate cells 516, 518. When the UE 502 performs an LTM, for example, when the signal quality from the serving cell 512 has degraded, the UE 502 may transition its connection from the serving cell 512 to another cell, such as the target cell 514 (e.g., via 532) to maintain continuous connectivity.

Similarly, the UE 502 may be configured with an HO (or CHO) cell set 520. The HO (or CHO) cell set 520 may include one or more cells, including cells 522, 524, 526, 528.

As shown in FIG. 5, if an LTM (or CLTM) failure occurs (e.g., the UE 502 fails to establish a connection with target cell 514), the UE 502 may perform the failure recovery by performing a handover scheme to one of its configured candidate cells in the HO (or CHO) cell set 520, such as cell 528 (via 534).

In some aspects, the selection of the candidate cell for CHO or LTM/CLTM recovery may be implemented in different ways. In one configuration, a cell may first be selected using an existing cell selection procedure (e.g., based on the signal measurements from the cell). Then, if the selected cell is identified as part of the set of CHO candidate cells (e.g., HO (or CHO) cell set 520) or LTM (or CLTM) candidate cells (e.g., LTM (or CLTM) cell set 510), the UE may use the selected cell for failure recovery following an LTM (or CLTM) failure or a CHO failure, respectively.

In another configuration, the UE may evaluate the configured CHO candidate cells (e.g., cells 522, 524, 526, 528) or LTM (or CLTM) candidate cells (e.g., candidate cells 516, 518) and select the best candidate cells among them for failure recovery following an LTM (or CLTM) failure or a CHO failure, respectively.

In some aspects, weights may be applied to candidate cells (e.g., CHO candidate cells or LTM (or CLTM) candidate cells) to prioritize certain CHO candidate cells or LTM (or CLTM) candidate cells over others. For example, CHO candidate cells or LTM (or CLTM) candidate cells associated with a time-to-trigger (TTT) event may be assigned higher weights, representing a higher priority. In some aspects, the network may configure the UE to support a specific recovery type. In some examples, the network may configure the UE to exclusively support CHO recovery (e.g., recovery using CHO candidate cells). In some examples, the network may configure the UE to exclusively support LTM (or CLTM) recovery (e.g., recovery using LTM (or CLTM) candidate cells). In some examples, the network may configure the UE to support CHO recovery (e.g., recovery using CHO candidate cells) or LTM (or CLTM) recovery (e.g., recovery using LTM (or CLTM) candidate cells).

In some aspects, the UE may trigger LTM (or CLTM) failure recovery proactively, before an actual LTM (or CLTM) failure occurs, such as before the expiration of a timer (e.g., the T304 timer), an RLF, or an SCG failure. In some examples, this early LTM (or CLTM) failure recovery may be triggered if one or more trigger conditions have been met.

In some examples, the trigger condition for the early failure recovery may be based on the parameters autonomously selected by the UE. For example, the UE may select (or determine) these parameters based on historical data related to the success or failure of previous LTM (or CLTM) or CHO switch events, or based on the predictions of timer expiry (e.g., T304 timer expiry), RLF, or SCG failure. For example, these predictions may be generated using a model, such as an artificial intelligence/machine learning (AI/ML) model. For example, the UE may select a threshold value for a timer (e.g., T304 timer) and trigger LTM (or CLTM) failure recovery when the timer reaches the threshold value, even if the timer has not yet expired.

In some examples, the trigger condition for the early failure recovery may be based on network-configured parameters. For example, the network may configure separate parameters to various timers (e.g., T304 timer), RLF, SCG failure, and other mobility-related settings, such as the maximum number of configured grant (CG) PUSCH transmissions for RACH-less cases or RACH-related parameters. For example, different parameters may be configured for different types of failure recovery cases. For example, different parameters may be applied for recovery from LTM to CHO, CHO to LTM, CLTM to CHO, or CHO to CLTM. As an example, the network may configure a first timer threshold for failure recovery from LTM to CHO and a second timer threshold for failure recovery from CHO to LTM. The UE then may initiate the corresponding failure recovery procedure (e.g., using the corresponding set of candidate cells) when the respective timer threshold is reached.

In some aspects, the cross handover scheme recovery mechanism may be applicable to various combinations of failure and recovery between LTM and CHO, and each of the LTM failure or recovery and the CHO failure or recovery can be RACH-based failure (or recovery) or RACH-less failure (or recovery). For example, the cross handover scheme recovery mechanism may be applicable for the failure recovery from a RACH-based LTM failure to a RACH-based CHO candidate cell, and vice versa (e.g., the failure recovery from the RACH-based CHO failure to a RACH-based LTM candidate cell). For example, the cross handover scheme recovery mechanism may be applicable for the failure recovery from a RACH-based LTM failure to a RACH-less CHO candidate cell, and vice versa (e.g., the failure recovery from a RACH-less CHO failure to a RACH-based LTM candidate cell). For example, the cross handover scheme recovery mechanism may be applicable for the failure recovery from a RACH-less LTM failure to a RACH-based CHO candidate cell, and vice versa (e.g., the failure recovery from a RACH-based CHO failure to a RACH-less LTM candidate cell). For example, the cross handover scheme recovery mechanism may be applicable for the failure recovery from a RACH-less LTM failure to a RACH-less CHO candidate cell, and vice versa (e.g., from a RACH-less CHO failure to a RACH-less LTM candidate cell).

For CLTM cases, the cross handover scheme recovery mechanism may be applicable to various combinations of failure and recovery between CLTM and CHO, and each of the CLTM failure or recovery and the CHO failure or recovery can be RACH-based failure (or recovery) or RACH-less failure (or recovery). For example, the cross handover scheme recovery mechanism may be applicable for the failure recovery from a RACH-based CLTM failure to a RACH-based CHO candidate cell, and vice versa (e.g., the failure recovery from the RACH-based CHO failure to a RACH-based CLTM candidate cell). For example, the cross handover scheme recovery mechanism may be applicable for the failure recovery from a RACH-based CLTM failure to a RACH-less CHO candidate cell, and vice versa (e.g., the failure recovery from a RACH-less CHO failure to a RACH-based CLTM candidate cell). For example, the cross handover scheme recovery mechanism may be applicable for the failure recovery from a RACH-less CLTM failure to a RACH-based CHO candidate cell, and vice versa (e.g., the failure recovery from a RACH-based CHO failure to a RACH-less CLTM candidate cell). For example, the cross handover scheme recovery mechanism may be applicable for the failure recovery from a RACH-less CLTM failure to a RACH-less CHO candidate cell, and vice versa (e.g., from a RACH-less CHO failure to a RACH-less CLTM candidate cell).

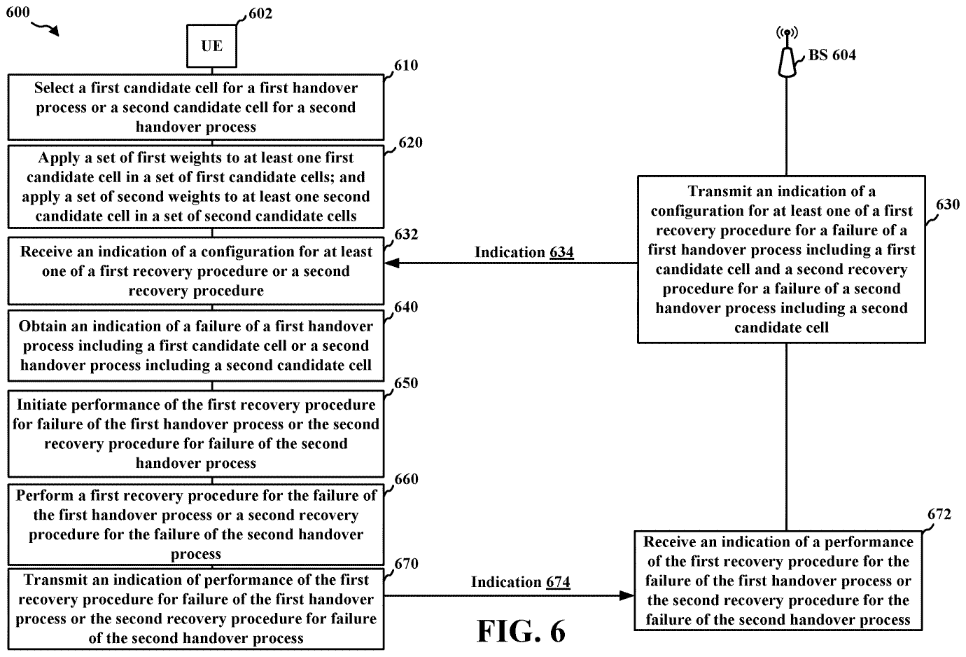

FIG. 6 is a communication flow diagram 600 illustrating example communication in accordance with one or more techniques of this disclosure. As shown in FIG. 6, diagram 600 includes example communications between UE 602 and base station 604, in accordance with one or more techniques of this disclosure.

At 610, UE 602 may select a first candidate cell for a first handover process or a second candidate cell for a second handover process. In some aspects, selecting the first candidate cell for the first handover process or the second candidate cell for the second handover process may include: selecting the first candidate cell for the first handover process or the second candidate cell for the second handover process; and determining whether the first candidate cell is valid for the first handover process or whether the second candidate cell is valid for the second handover process. Also, selecting the first candidate cell for the first handover process or the second candidate cell for the second handover process may include: selecting the first candidate cell from a set of first candidate cells for the first handover process or the second candidate cell from a set of second candidate cells for the second handover process.

At 620, UE 602 may apply, prior to selection of the first candidate cell, a set of first weights to at least one first candidate cell in a set of first candidate cells; and apply, prior to selection of the second candidate cell, a set of second weights to at least one second candidate cell in a set of second candidate cells.

At 630, base station 604 may transmit, to a user equipment (UE), an indication of a configuration for at least one of a first recovery procedure for a failure of a first handover process including a first candidate cell and a second recovery procedure for a failure of a second handover process including a second candidate cell. For example, base station 604 may transmit indication 634 to UE 602. In some aspects, a detection of the failure of the first handover process including the first candidate cell or the second handover process including the second candidate cell may be based on an expiration of a timer. The failure of the first handover process or the second handover process may be a radio link failure (RLF). Also, the failure of the first handover process or the second handover process may be a master cell group (MCG) failure or a secondary cell group (SCG) failure. Further, the timer may be a T304 timer. Also, the indication of the configuration may include at least one of a set of first recovery parameters for the first recovery procedure or a set of second recovery parameters for the second recovery procedure.

At 632, UE 602 may receive, from a network node, an indication of a configuration for at least one of a first recovery procedure or a second recovery procedure. For example, the UE 602 may receive indication 634 from base station 604. In some aspects, the indication of the configuration may include at least one of a set of first recovery parameters for the first recovery procedure or a set of second recovery parameters for the second recovery procedure.

At 640, UE 602 may obtain an indication of a failure of a first handover process including a first candidate cell or a second handover process including a second candidate cell. In some aspects, obtaining the indication of the failure of the first handover process including the first candidate cell or the second handover process including the second candidate cell may include: detecting, at the UE, the failure of the first handover process including the first candidate cell or the second handover process including the second candidate cell. Also, detecting, at the UE, the failure of the first handover process including the first candidate cell or the second handover process including the second candidate cell may include: detecting, based on an expiration of a timer at the UE, the failure of the first handover process including the first candidate cell or the second handover process including the second candidate cell. The failure of the first handover process or the second handover process may be a radio link failure (RLF). Also, failure of the first handover process or the second handover process may be a master cell group (MCG) failure or a secondary cell group (SCG) failure. Moreover, the timer may be a T304 timer at the UE.

At 650, UE 602 may initiate, at the UE, performance of a first recovery procedure for the failure of the first handover process or a second recovery procedure for the failure of the second handover process. In some aspects, initiating the performance of the first recovery procedure or the second recovery procedure may include: initiating, prior to an expiration of a timer at the UE, the performance of the first recovery procedure or the second recovery procedure. Also, initiating, prior to the expiration of the timer at the UE, the performance of the first recovery procedure or the second recovery procedure may include: initiating, prior to the expiration of the timer at the UE, the performance of the first recovery procedure or the second recovery procedure based on at least one of (1) data for a switch success/failure or (2) an artificial intelligence (AI) or machine learning (ML) (AI/ML) prediction of the expiration of the timer.

At 660, UE 602 may perform a first recovery procedure for the failure of the first handover process or a second recovery procedure for the failure of the second handover process. In some aspects, performing the first recovery procedure for the failure of the first handover process may include switching from the first handover process to the second handover process. Also, performing the second recovery procedure for the failure of the second handover process may include switching from the second handover process to the first handover process. The first handover process may be a handover (HO) process, a conditional HO (CHO) process, or a conditional primary secondary cell (PScell) change (CPC) process, and the second handover process may be a lower layer triggered mobility (LTM) process or a conditional LTM (CLTM) process.

At 670, UE 602 may transmit an indication of the performance of the first recovery procedure for the failure of the first handover process or the second recovery procedure for the failure of the second handover process. For example, the UE 602 may transmit indication 674 to base station 604. In some aspects, transmitting the indication of the performance of the first recovery procedure for the failure of the first handover process or the second recovery procedure for the failure of the second handover process may include: transmitting, to a network node, a report of the performance of the first recovery procedure for the failure of the first handover process or the second recovery procedure for the failure of the second handover process.

At 672, base station 604 may receive, from the UE, an indication of the performance of the first recovery procedure for the failure of the first handover process or the second recovery procedure for the failure of the second handover process. For example, base station 604 may receive indication 674 from UE 602. In some aspects, the performance of the first recovery procedure for the failure of the first handover process may include a switch from the first handover process to the second handover process; and the performance of the second recovery procedure for the failure of the second handover process may include a switch from the second handover process to the first handover process. Also, the first handover process may be a handover (HO) process, a conditional HO (CHO) process, or a conditional primary secondary cell (PScell) change (CPC) process, and the second handover process may be a lower layer triggered mobility (LTM) process or a conditional LTM (CLTM) process. Further, the performance of the first recovery procedure or the second recovery procedure may be based on at least one of (1) data for a switch success/failure or (2) an artificial intelligence (AI) or machine learning (ML) (AI/ML) prediction of the expiration of the timer. Moreover, receiving the indication of the performance of the first recovery procedure for the failure of the first handover process or the second recovery procedure for the failure of the second handover process may include: receiving, from the UE, a report of the performance of the first recovery procedure for the failure of the first handover process or the second recovery procedure for the failure of the second handover process.

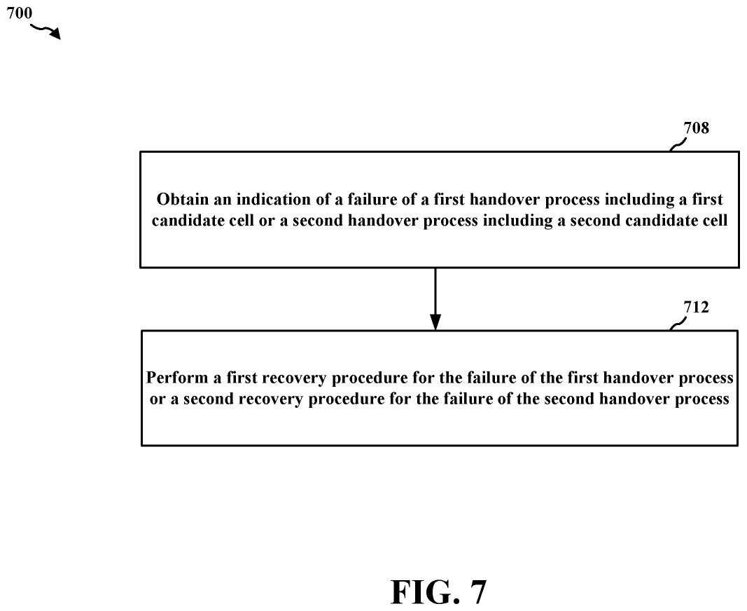

FIG. 7 is a flowchart 700 of a method of wireless communication in accordance with one or more techniques of this disclosure. The method may be performed by a UE (e.g., the UE 104, UE 602; the apparatus 1004), and/or any apparatus that may perform communication as used in connection with the examples of FIGS. 1-6.

At 708, the UE may obtain an indication of a failure of a first handover process including a first candidate cell or a second handover process including a second candidate cell, as described in connection with the examples in FIGS. 1-6. For example, as described in 640 of FIG. 6, UE 602 may obtain an indication of a failure of a first handover process including a first candidate cell or a second handover process including a second candidate cell. Further, step 708 may be performed by recovery component 198 in FIG. 1. In some aspects, obtaining the indication of the failure of the first handover process including the first candidate cell or the second handover process including the second candidate cell may include: detecting, at the UE, the failure of the first handover process including the first candidate cell or the second handover process including the second candidate cell. Also, detecting, at the UE, the failure of the first handover process including the first candidate cell or the second handover process including the second candidate cell may include: detecting, based on an expiration of a timer at the UE, the failure of the first handover process including the first candidate cell or the second handover process including the second candidate cell. The failure of the first handover process or the second handover process may be a radio link failure (RLF). Also, failure of the first handover process or the second handover process may be a master cell group (MCG) failure or a secondary cell group (SCG) failure. Moreover, the timer may be a T304 timer at the UE.

At 712, the UE may perform a first recovery procedure for the failure of the first handover process or a second recovery procedure for the failure of the second handover process, as described in connection with the examples in FIGS. 1-6. For example, as described in 660 of FIG. 6, UE 602 may perform a first recovery procedure for the failure of the first handover process or a second recovery procedure for the failure of the second handover process. Further, step 712 may be performed by recovery component 198 in FIG. 1. In some aspects, performing the first recovery procedure for the failure of the first handover process may include switching from the first handover process to the second handover process. Also, performing the second recovery procedure for the failure of the second handover process may include switching from the second handover process to the first handover process. The first handover process may be a handover (HO) process, a conditional HO (CHO) process, or a conditional primary secondary cell (PScell) change (CPC) process, and the second handover process may be a lower layer triggered mobility (LTM) process or a conditional LTM (CLTM) process.

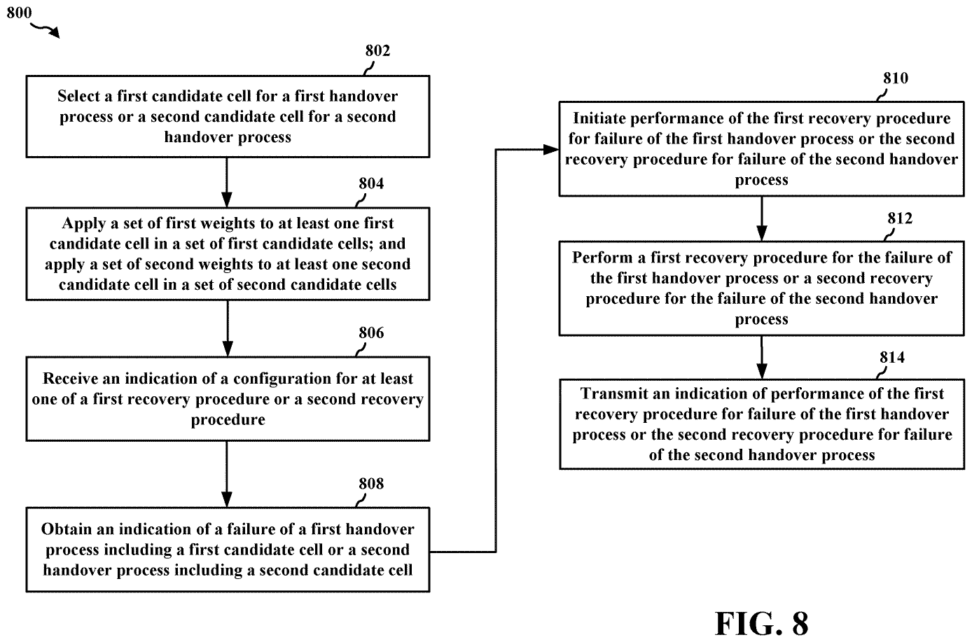

FIG. 8 is a flowchart 800 of a method of wireless communication in accordance with one or more techniques of this disclosure. The method may be performed by a UE (e.g., the UE 104, UE 602; the apparatus 1004), and/or any apparatus that may perform communication as used in connection with the examples of FIGS. 1-6.

At 802, the UE may select a first candidate cell for a first handover process or a second candidate cell for a second handover process, as described in connection with the examples in FIGS. 1-6. For example, as described in 610 of FIG. 6, UE 602 may select a first candidate cell for a first handover process or a second candidate cell for a second handover process. Further, step 802 may be performed by recovery component 198 in FIG. 1. In some aspects, selecting the first candidate cell for the first handover process or the second candidate cell for the second handover process may include: selecting the first candidate cell for the first handover process or the second candidate cell for the second handover process; and determining whether the first candidate cell is valid for the first handover process or whether the second candidate cell is valid for the second handover process. Also, selecting the first candidate cell for the first handover process or the second candidate cell for the second handover process may include: selecting the first candidate cell from a set of first candidate cells for the first handover process or the second candidate cell from a set of second candidate cells for the second handover process.

At 804, the UE may apply, prior to selection of the first candidate cell, a set of first weights to at least one first candidate cell in a set of first candidate cells; and apply, prior to selection of the second candidate cell, a set of second weights to at least one second candidate cell in a set of second candidate cells, as described in connection with the examples in FIGS. 1-6. For example, as described in 620 of FIG. 6, UE 602 may apply, prior to selection of the first candidate cell, a set of first weights to at least one first candidate cell in a set of first candidate cells; and apply, prior to selection of the second candidate cell, a set of second weights to at least one second candidate cell in a set of second candidate cells. Further, step 804 may be performed by recovery component 198 in FIG. 1.

At 806, the UE may receive, from a network node, an indication of a configuration for at least one of a first recovery procedure or a second recovery procedure, as described in connection with the examples in FIGS. 1-6. For example, as described in 632 of FIG. 6, UE 602 may receive, from a network node, an indication of a configuration for at least one of a first recovery procedure or a second recovery procedure. Further, step 806 may be performed by recovery component 198 in FIG. 1. For example, the UE 602 may receive indication 634 from base station 604. In some aspects, the indication of the configuration may include at least one of a set of first recovery parameters for the first recovery procedure or a set of second recovery parameters for the second recovery procedure.

At 808, the UE may obtain an indication of a failure of a first handover process including a first candidate cell or a second handover process including a second candidate cell, as described in connection with the examples in FIGS. 1-6. For example, as described in 640 of FIG. 6, UE 602 may obtain an indication of a failure of a first handover process including a first candidate cell or a second handover process including a second candidate cell. Further, step 808 may be performed by recovery component 198 in FIG. 1. In some aspects, obtaining the indication of the failure of the first handover process including the first candidate cell or the second handover process including the second candidate cell may include: detecting, at the UE, the failure of the first handover process including the first candidate cell or the second handover process including the second candidate cell. Also, detecting, at the UE, the failure of the first handover process including the first candidate cell or the second handover process including the second candidate cell may include: detecting, based on an expiration of a timer at the UE, the failure of the first handover process including the first candidate cell or the second handover process including the second candidate cell. The failure of the first handover process or the second handover process may be a radio link failure (RLF). Also, failure of the first handover process or the second handover process may be a master cell group (MCG) failure or a secondary cell group (SCG) failure. Moreover, the timer may be a T304 timer at the UE.

At 810, the UE may initiate, at the UE, performance of a first recovery procedure for the failure of the first handover process or a second recovery procedure for the failure of the second handover process, as described in connection with the examples in FIGS. 1-6. For example, as described in 650 of FIG. 6, UE 602 may initiate, at the UE, performance of a first recovery procedure for the failure of the first handover process or a second recovery procedure for the failure of the second handover process. Further, step 810 may be performed by recovery component 198 in FIG. 1. In some aspects, initiating the performance of the first recovery procedure or the second recovery procedure may include: initiating, prior to an expiration of a timer at the UE, the performance of the first recovery procedure or the second recovery procedure. Also, initiating, prior to the expiration of the timer at the UE, the performance of the first recovery procedure or the second recovery procedure may include: initiating, prior to the expiration of the timer at the UE, the performance of the first recovery procedure or the second recovery procedure based on at least one of (1) data for a switch success/failure or (2) an artificial intelligence (AI) or machine learning (ML) (AI/ML) prediction of the expiration of the timer.

At 812, the UE may perform a first recovery procedure for the failure of the first handover process or a second recovery procedure for the failure of the second handover process, as described in connection with the examples in FIGS. 1-6. For example, as described in 660 of FIG. 6, UE 602 may perform a first recovery procedure for the failure of the first handover process or a second recovery procedure for the failure of the second handover process. Further, step 812 may be performed by recovery component 198 in FIG. 1. In some aspects, performing the first recovery procedure for the failure of the first handover process may include switching from the first handover process to the second handover process. Also, performing the second recovery procedure for the failure of the second handover process may include switching from the second handover process to the first handover process. The first handover process may be a handover (HO) process, a conditional HO (CHO) process, or a conditional primary secondary cell (PScell) change (CPC) process, and the second handover process may be a lower layer triggered mobility (LTM) process or a conditional LTM (CLTM) process.

At 814, the UE may transmit an indication of the performance of the first recovery procedure for the failure of the first handover process or the second recovery procedure for the failure of the second handover process, as described in connection with the examples in FIGS. 1-6. For example, as described in 670 of FIG. 6, UE 602 may transmit an indication of the performance of the first recovery procedure for the failure of the first handover process or the second recovery procedure for the failure of the second handover process. Further, step 814 may be performed by recovery component 198 in FIG. 1. For example, the UE 602 may transmit indication 674 to base station 604. In some aspects, transmitting the indication of the performance of the first recovery procedure for the failure of the first handover process or the second recovery procedure for the failure of the second handover process may include: transmitting, to a network node, a report of the performance of the first recovery procedure for the failure of the first handover process or the second recovery procedure for the failure of the second handover process.

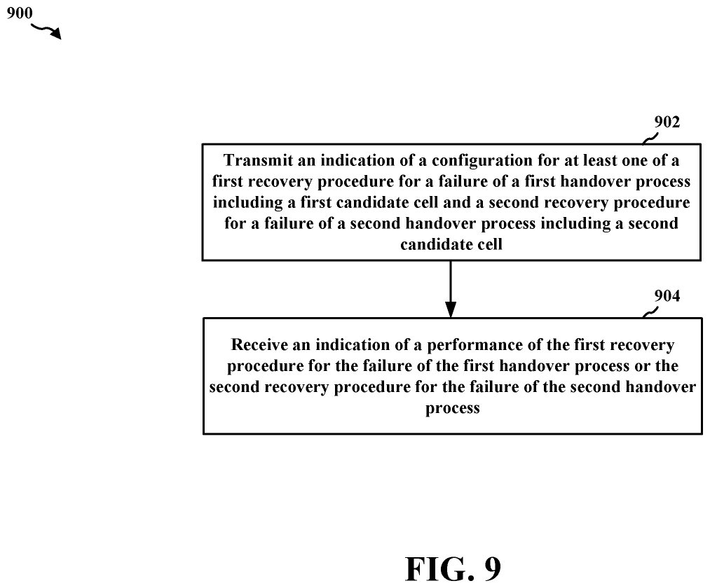

FIG. 9 is a flowchart 900 of a method of wireless communication in accordance with one or more techniques of this disclosure. The method may be performed by a base station (e.g., the base station 102, base station 604; the network entity 1002, 1102), and/or any apparatus that may perform communication as used in connection with the examples of FIGS. 1-6.

At 902, the base station may transmit, to a user equipment (UE), an indication of a configuration for at least one of a first recovery procedure for a failure of a first handover process including a first candidate cell and a second recovery procedure for a failure of a second handover process including a second candidate cell, as described in connection with the examples in FIGS. 1-6. For example, as described in 630 of FIG. 8, base station 604 may transmit, to a user equipment (UE), an indication of a configuration for at least one of a first recovery procedure for a failure of a first handover process including a first candidate cell and a second recovery procedure for a failure of a second handover process including a second candidate cell. Further, step 902 may be performed by recovery component 199 in FIG. 1. For example, base station 604 may transmit indication 634 to UE 602. In some aspects, a detection of the failure of the first handover process including the first candidate cell or the second handover process including the second candidate cell may be based on an expiration of a timer. The failure of the first handover process or the second handover process may be a radio link failure (RLF). Also, the failure of the first handover process or the second handover process may be a master cell group (MCG) failure or a secondary cell group (SCG) failure. Further, the timer may be a T304 timer. Also, the indication of the configuration may include at least one of a set of first recovery parameters for the first recovery procedure or a set of second recovery parameters for the second recovery procedure.

At 904, the base station may receive, from the UE, an indication of the performance of the first recovery procedure for the failure of the first handover process or the second recovery procedure for the failure of the second handover process, as described in connection with the examples in FIGS. 1-6. For example, as described in 672 of FIG. 8, base station 604 may receive, from the UE, an indication of the performance of the first recovery procedure for the failure of the first handover process or the second recovery procedure for the failure of the second handover process. Further, step 904 may be performed by recovery component 199 in FIG. 1. For example, base station 604 may receive indication 674 from UE 602. In some aspects, the performance of the first recovery procedure for the failure of the first handover process may include a switch from the first handover process to the second handover process; and the performance of the second recovery procedure for the failure of the second handover process may include a switch from the second handover process to the first handover process. Also, the first handover process may be a handover (HO) process, a conditional HO (CHO) process, or a conditional primary secondary cell (PScell) change (CPC) process, and the second handover process may be a lower layer triggered mobility (LTM) process or a conditional LTM (CLTM) process. Further, the performance of the first recovery procedure or the second recovery procedure may be based on at least one of (1) data for a switch success/failure or (2) an artificial intelligence (AI) or machine learning (ML) (AI/ML) prediction of the expiration of the timer. Moreover, receiving the indication of the performance of the first recovery procedure for the failure of the first handover process or the second recovery procedure for the failure of the second handover process may include: receiving, from the UE, a report of the performance of the first recovery procedure for the failure of the first handover process or the second recovery procedure for the failure of the second handover process.

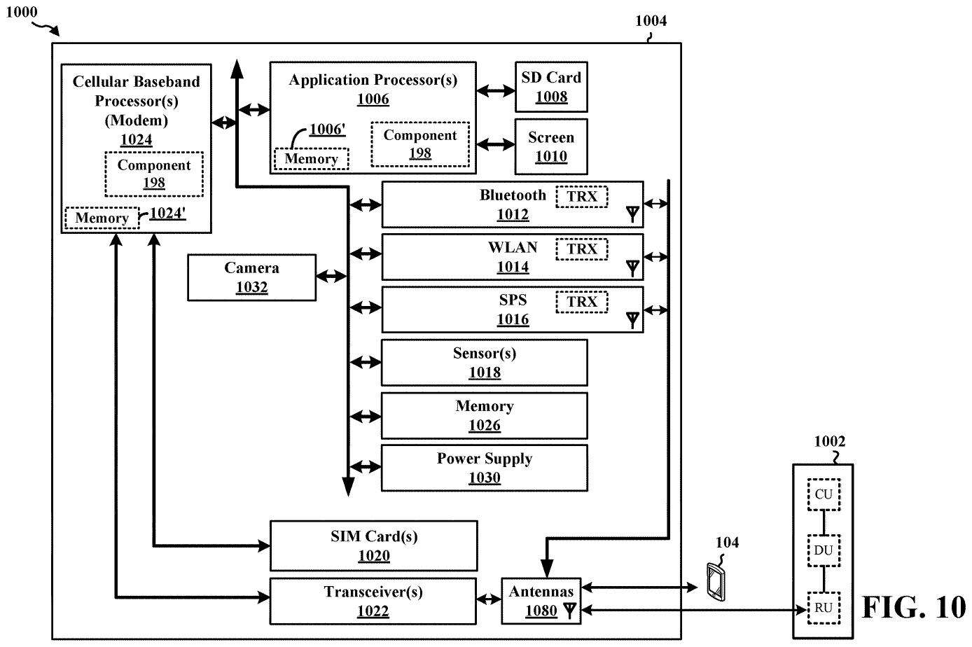

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include at least one cellular baseband processor (or processing circuitry) 1024 (also referred to as a modem) coupled to one or more transceivers 1022 (e.g., cellular RF transceiver). The cellular baseband processor(s) (or processing circuitry) 1024 may include at least one on-chip memory (or memory circuitry) 1024′. In some aspects, the apparatus 1004 may further include one or more subscriber identity modules (SIM) cards 1020 and at least one application processor (or processing circuitry) 1006 coupled to a secure digital (SD) card 1008 and a screen 1010. The application processor(s) (or processing circuitry) 1006 may include on-chip memory (or memory circuitry) 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor(s) (or processing circuitry) 1024 communicates through the transceiver(s) 1022 via one or more antennas 1080 with the UE 104 and/or with an RU associated with a network entity 1002. The cellular baseband processor(s) (or processing circuitry) 1024 and the application processor(s) (or processing circuitry) 1006 may each include a computer-readable medium/memory (or memory circuitry) 1024′, 1006′, respectively. The additional memory modules 1026 may also be considered a computer-readable medium/memory (or memory circuitry). Each computer-readable medium/memory (or memory circuitry) 1024′, 1006′, 1026 may be non-transitory. The cellular baseband processor(s) (or processing circuitry) 1024 and the application processor(s) (or processing circuitry) 1006 are each responsible for general processing, including the execution of software stored on the computer-readable medium/memory (or memory circuitry). The software, when executed by the cellular baseband processor(s) (or processing circuitry) 1024/application processor(s) (or processing circuitry) 1006, causes the cellular baseband processor(s) (or processing circuitry) 1024/application processor(s) (or processing circuitry) 1006 to perform the various functions described supra. The cellular baseband processor(s) (or processing circuitry) 1024 and the application processor(s) (or processing circuitry) 1006 are configured to perform the various functions described supra based at least in part of the information stored in the memory (or memory circuitry). That is, the cellular baseband processor(s) (or processing circuitry) 1024 and the application processor(s) (or processing circuitry) 1006 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1024/application processor(s) (or processing circuitry) 1006 when executing software. The cellular baseband processor(s) (or processing circuitry) 1024/application processor(s) (or processing circuitry) 1006 may be a component of the UE 350 and may include the at least one memory 360 and/or at least one of the TX processor 368, the RX processor 356, and the controller/processor 359. In one configuration, the apparatus 1004 may be at least one processor chip (modem and/or application) and include just the cellular baseband processor(s) (or processing circuitry) 1024 and/or the application processor(s) (or processing circuitry) 1006, and in another configuration, the apparatus 1004 may be the entire UE (e.g., see UE 350 of FIG. 3) and include the additional modules of the apparatus 1004.

As discussed supra, the component 198 may be configured to select a first candidate cell for a first handover process or a second candidate cell for a second handover process. The component 198 may also be configured to apply, prior to selection of the first candidate cell, a set of first weights to at least one first candidate cell in a set of first candidate cells; and apply, prior to selection of the second candidate cell, a set of second weights to at least one second candidate cell in a set of second candidate cells. The component 198 may also be configured to receive, from a network node, an indication of a configuration for at least one of a first recovery procedure or a second recovery procedure. The component 198 may also be configured to obtain an indication of a failure of a first handover process including a first candidate cell or a second handover process including a second candidate cell. The component 198 may also be configured to initiate, at the UE, performance of a first recovery procedure for the failure of the first handover process or a second recovery procedure for the failure of the second handover process. The component 198 may also be configured to perform a first recovery procedure for the failure of the first handover process or a second recovery procedure for the failure of the second handover process. The component 198 may also be configured to transmit an indication of performance of the first recovery procedure for the failure of the first handover process or the second recovery procedure for the failure of the second handover process. The component 198 may be further configured to perform any of the aspects described in connection with the flowcharts in FIG. 7 and FIG. 8, and/or performed by the UE 602 in FIG. 6. The component 198 may be within the cellular baseband processor(s) (or processing circuitry) 1024, the application processor(s) (or processing circuitry) 1006, or both the cellular baseband processor(s) (or processing circuitry) 1024 and the application processor(s) (or processing circuitry) 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) (or processing circuitry) 1024 and/or the application processor(s) (or processing circuitry) 1006, may include means for selecting a first candidate cell for a first handover process or a second candidate cell for a second handover process. The apparatus 1004, and in particular the cellular baseband processor(s) 1024 and/or the application processor(s) 1006, may also include means for applying, prior to selection of the first candidate cell, a set of first weights to at least one first candidate cell in a set of first candidate cells; and means for applying, prior to selection of the second candidate cell, a set of second weights to at least one second candidate cell in a set of second candidate cells. The apparatus 1004, and in particular the cellular baseband processor(s) 1024 and/or the application processor(s) 1006, may also include means for receiving, from a network node, an indication of a configuration for at least one of a first recovery procedure or a second recovery procedure. The apparatus 1004, and in particular the cellular baseband processor(s) 1024 and/or the application processor(s) 1006, may also include means for obtaining an indication of a failure of a first handover process including a first candidate cell or a second handover process including a second candidate cell. The apparatus 1004, and in particular the cellular baseband processor(s) 1024 and/or the application processor(s) 1006, may also include means for initiating, at the UE, performance of a first recovery procedure for the failure of the first handover process or a second recovery procedure for the failure of the second handover process. The apparatus 1004, and in particular the cellular baseband processor(s) 1024 and/or the application processor(s) 1006, may also include means for performing a first recovery procedure for the failure of the first handover process or a second recovery procedure for the failure of the second handover process. The apparatus 1004, and in particular the cellular baseband processor(s) 1024 and/or the application processor(s) 1006, may also include means for transmitting an indication of performance of the first recovery procedure for the failure of the first handover process or the second recovery procedure for the failure of the second handover process. The apparatus 1004 may further include means for performing any of the aspects described in connection with the flowcharts in FIG. 7 and FIG. 8, and/or aspects performed by the UE 602 in FIG. 6. The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

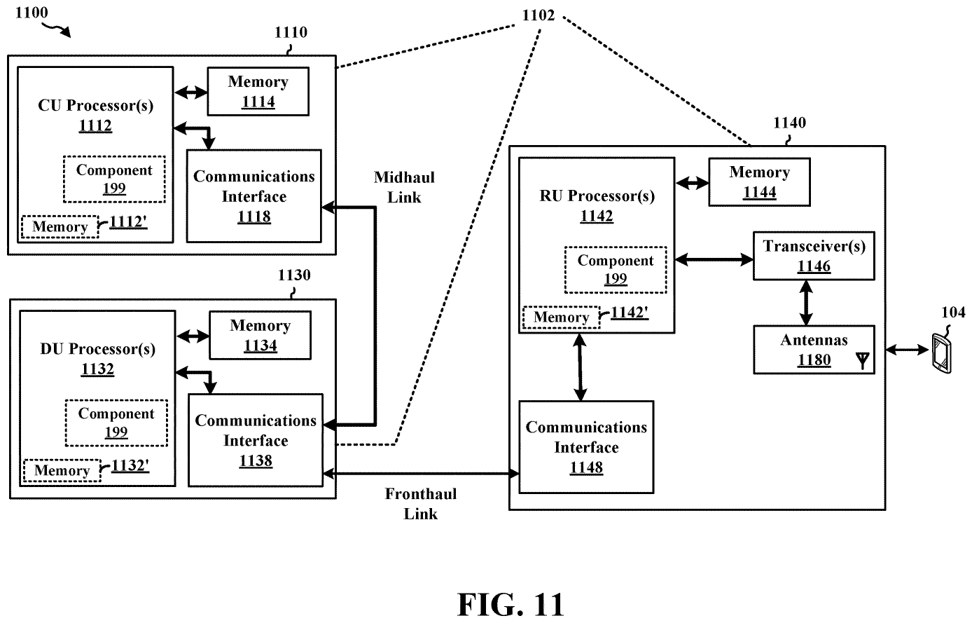

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor (or processing circuitry) 1112. The CU processor(s) (or processing circuitry) 1112 may include on-chip memory (or memory circuitry) 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor (or processing circuitry) 1132. The DU processor(s) (or processing circuitry) 1132 may include on-chip memory (or memory circuitry) 1132′. In some aspects, the DU 1130 may further include additional memory modules 1134 and a communications interface 1138. The DU 1130 communicates with the RU 1140 through a fronthaul link. The RU 1140 may include at least one RU processor (or processing circuitry) 1142. The RU processor(s) (or processing circuitry) 1142 may include on-chip memory (or memory circuitry) 1142′. In some aspects, the RU 1140 may further include additional memory modules 1144, one or more transceivers 1146, antennas 1180, and a communications interface 1148. The RU 1140 communicates with the UE 104. The on-chip memory (or memory circuitry) 1112′, 1132′, 1142′ and the additional memory modules 1114, 1134, 1144 may each be considered a computer-readable medium/memory (or memory circuitry). Each computer-readable medium/memory (or memory circuitry) may be non-transitory. Each of the processors (or processing circuitry) 1112, 1132, 1142 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, to a UE, an indication of a configuration for at least one of a first recovery procedure for a failure of a first handover process including a first candidate cell and a second recovery procedure for a failure of a second handover process including a second candidate cell; and receive, from the UE, an indication of a performance of the first recovery procedure for the failure of the first handover process or the second recovery procedure for the failure of the second handover process. The component 199 may be further configured to perform any of the aspects described in connection with the flowchart in FIG. 9, and/or performed by the base station 604 in FIG. 6. The component 199 may be within one or more processors (or processing circuitry) of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In one configuration, the network entity 1102 includes means for transmitting, to a UE, an indication of a configuration for at least one of a first recovery procedure for a failure of a first handover process including a first candidate cell and a second recovery procedure for a failure of a second handover process including a second candidate cell; and means for receiving, from the UE, an indication of a performance of the first recovery procedure for the failure of the first handover process or the second recovery procedure for the failure of the second handover process. The network entity 1102 may further include means for performing any of the aspects described in connection with the flowchart in FIG. 9, and/or aspects performed by the base station 604 in FIG. 6. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include obtaining an indication of a failure of a first handover process including a first candidate cell or a second handover process including a second candidate cell; and performing a first recovery procedure for the failure of the first handover process or a second recovery procedure for the failure of the second handover process. By enabling recovery from LTM or CLTM failure to CHO/CPC candidate cells (and vice versa), the methods reduce the handover recovery latency and avoid the need for the full RRC re-establishment, thereby improving handover reliability and reducing recovery latency. Additionally, by allowing the UE to evaluate both CHO and CLTM candidate cells with configurable weighting and selection criteria, the methods prioritize recovery paths that are more reliable or time-sensitive based on real-time network conditions or ongoing mobility events, thereby enhancing robustness and service continuity during failure scenarios. In some examples, by enabling early triggering of LTM/CLTM recovery, the methods proactively prevent service disruption based on predictive modeling, historical data, or network-configured thresholds, thereby further enhancing communication reliability.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.”

The following aspects are illustrative only and may be combined with other aspects or teachings described herein, without limitation.

Aspect 1 is an apparatus for wireless communication at a user equipment (UE), including at least one memory and at least one processor coupled to the at least one memory and, based at least in part on information stored in the at least one memory, the at least one processor, individually or in any combination, is configured to: obtain an indication of a failure of a first handover process including a first candidate cell or a second handover process including a second candidate cell; and perform a first recovery procedure for the failure of the first handover process or a second recovery procedure for the failure of the second handover process.

Aspect 2 is the apparatus of aspect 1, wherein to perform the first recovery procedure for the failure of the first handover process, the at least one processor is configured to switch from the first handover process to the second handover process; and wherein to perform the second recovery procedure for the failure of the second handover process, the at least one processor is configured to switch from the second handover process to the first handover process.

Aspect 3 is the apparatus of aspect 2, wherein the first handover process is a handover (HO) process, a conditional HO (CHO) process, or a conditional primary secondary cell (PScell) change (CPC) process, and wherein the second handover process is a lower layer triggered mobility (LTM) process or a conditional LTM (CLTM) process.

Aspect 4 is the apparatus of any of aspects 1 to 3, wherein to obtain the indication of the failure of the first handover process including the first candidate cell or the second handover process including the second candidate cell, the at least one processor is configured to: detect, at the UE, the failure of the first handover process including the first candidate cell or the second handover process including the second candidate cell.

Aspect 5 is the apparatus of aspect 4, wherein to detect, at the UE, the failure of the first handover process including the first candidate cell or the second handover process including the second candidate cell, the at least one processor is configured to: detect, based on an expiration of a timer at the UE, the failure of the first handover process including the first candidate cell or the second handover process including the second candidate cell.

Aspect 6 is the apparatus of aspect 5, wherein the failure of the first handover process or the second handover process is a radio link failure (RLF).

Aspect 7 is the apparatus of any of aspects 5 to 6, wherein the failure of the first handover process or the second handover process is a master cell group (MCG) failure or a secondary cell group (SCG) failure.

Aspect 8 is the apparatus of any of aspects 5 to 7, wherein the timer is a T304 timer at the UE.

Aspect 9 is the apparatus of any of aspects 1 to 8, wherein the at least one processor is further configured to: select the first candidate cell for the first handover process or the second candidate cell for the second handover process.

Aspect 10 is the apparatus of aspect 9, wherein to select the first candidate cell for the first handover process or the second candidate cell for the second handover process, the at least one processor is configured to: select the first candidate cell for the first handover process or the second candidate cell for the second handover process; and determine whether the first candidate cell is valid for the first handover process or whether the second candidate cell is valid for the second handover process.

Aspect 11 is the apparatus of any of aspects 9 to 10, wherein to select the first candidate cell for the first handover process or the second candidate cell for the second handover process, the at least one processor is configured to: select the first candidate cell from a set of first candidate cells for the first handover process or the second candidate cell from a set of second candidate cells for the second handover process.

Aspect 12 is the apparatus of aspect 11, wherein the at least one processor is further configured to: apply, prior to selection of the first candidate cell, a set of first weights to at least one first candidate cell in the set of first candidate cells; and apply, prior to selection of the second candidate cell, a set of second weights to at least one second candidate cell in the set of second candidate cells.

Aspect 13 is the apparatus of any of aspects 1 to 12, wherein the at least one processor is further configured to: initiate, at the UE, performance of the first recovery procedure for the failure of the first handover process or the second recovery procedure for the failure of the second handover process.

Aspect 14 is the apparatus of aspect 13, wherein to initiate the performance of the first recovery procedure or the second recovery procedure, the at least one processor is configured to: initiate, prior to an expiration of a timer at the UE, the performance of the first recovery procedure or the second recovery procedure.

Aspect 15 is the apparatus of aspect 14, wherein to initiate, prior to the expiration of the timer at the UE, the performance of the first recovery procedure or the second recovery procedure, the at least one processor is configured to: initiate, prior to the expiration of the timer at the UE, the performance of the first recovery procedure or the second recovery procedure based on at least one of (1) data for a switch success/failure or (2) an artificial intelligence (AI) or machine learning (ML) (AI/ML) prediction of the expiration of the timer.

Aspect 16 is the apparatus of any of aspects 1 to 15, wherein the at least one processor is further configured to: receive, from a network node, an indication of a configuration for at least one of the first recovery procedure or the second recovery procedure.

Aspect 17 is the apparatus of aspect 16, wherein the indication of the configuration includes at least one of a set of first recovery parameters for the first recovery procedure or a set of second recovery parameters for the second recovery procedure.

Aspect 18 is the apparatus of any of aspects 1 to 17, wherein the at least one processor is further configured to: transmit an indication of performance of the first recovery procedure for the failure of the first handover process or the second recovery procedure for the failure of the second handover process.

Aspect 19 is the apparatus of aspect 18, wherein to transmit the indication of the performance of the first recovery procedure for the failure of the first handover process or the second recovery procedure for the failure of the second handover process, the at least one processor is configured to: transmit, to a network node, a report of the performance of the first recovery procedure for the failure of the first handover process or the second recovery procedure for the failure of the second handover process.

Aspect 20 is the apparatus of aspect 19, further including (i.e., comprising) at least one of an antenna or a transceiver coupled to the at least one processor, wherein to transmit the report of the performance of the first recovery procedure for the failure of the first handover process or the second recovery procedure for the failure of the second handover process, the at least one processor is configured to: transmit, via at least one of the antenna or the transceiver, the report of the performance of the first recovery procedure for the failure of the first handover process or the second recovery procedure for the failure of the second handover process.

Aspect 21 is the apparatus of any of aspects 1 to 20, wherein the apparatus is a wireless communication device.

Aspect 22 is a method of communication for implementing any of aspects 1 to 21.

Aspect 23 is an apparatus for communication including means for implementing any of aspects 1 to 21.

Aspect 24 is a computer-readable medium (e.g., a non-transitory computer-readable medium) storing computer executable code (e.g., code for wireless communication), the code when executed by at least one processor causes the at least one processor to implement any of aspects 1 to 21.

Aspect 25 is an apparatus for wireless communication at a network node, including at least one memory and at least one processor coupled to the at least one memory and, based at least in part on information stored in the at least one memory, the at least one processor, individually or in any combination, is configured to: transmit, to a user equipment (UE), an indication of a configuration for at least one of a first recovery procedure for a failure of a first handover process including a first candidate cell and a second recovery procedure for a failure of a second handover process including a second candidate cell; and receive, from the UE, an indication of a performance of the first recovery procedure for the failure of the first handover process or the second recovery procedure for the failure of the second handover process.

Aspect 26 is the apparatus of aspect 25, wherein the performance of the first recovery procedure for the failure of the first handover process comprises a switch from the first handover process to the second handover process; and wherein the performance of the second recovery procedure for the failure of the second handover process comprises a switch from the second handover process to the first handover process.

Aspect 27 is the apparatus of aspect 26, wherein the first handover process is a handover (HO) process, a conditional HO (CHO) process, or a conditional primary secondary cell (PScell) change (CPC) process, and wherein the second handover process is a lower layer triggered mobility (LTM) process or a conditional LTM (CLTM) process.

Aspect 28 is the apparatus of any of aspects 25 to 27, wherein a detection of the failure of the first handover process including the first candidate cell or the second handover process including the second candidate cell is based on an expiration of a timer.

Aspect 29 is the apparatus of aspect 28, wherein the failure of the first handover process or the second handover process is a radio link failure (RLF).

Aspect 30 is the apparatus of any of aspects 28 to 29, wherein the failure of the first handover process or the second handover process is a master cell group (MCG) failure or a secondary cell group (SCG) failure.

Aspect 31 is the apparatus of any of aspects 28 to 30, wherein the timer is a T304 timer.

Aspect 32 is the apparatus of any of aspects 28 to 31, wherein the performance of the first recovery procedure or the second recovery procedure is based on at least one of (1) data for a switch success/failure or (2) an artificial intelligence (AI) or machine learning (ML) (AI/ML) prediction of the expiration of the timer.

Aspect 33 is the apparatus of any of aspects 25 to 32, wherein the indication of the configuration includes at least one of a set of first recovery parameters for the first recovery procedure or a set of second recovery parameters for the second recovery procedure.

Aspect 34 is the apparatus of any of aspects 25 to 33, wherein to receive the indication of the performance of the first recovery procedure for the failure of the first handover process or the second recovery procedure for the failure of the second handover process, the at least one processor is configured to: receive, from the UE, a report of the performance of the first recovery procedure for the failure of the first handover process or the second recovery procedure for the failure of the second handover process.

Aspect 35 is the apparatus of aspect 34, further including (i.e., comprising) at least one of an antenna or a transceiver coupled to the at least one processor, wherein to receive, the report of the performance of the first recovery procedure for the failure of the first handover process or the second recovery procedure for the failure of the second handover process, the at least one processor is configured to: receive, via at least one of the antenna or the transceiver, the report of the performance of the first recovery procedure for the failure of the first handover process or the second recovery procedure for the failure of the second handover process.

Aspect 36 is the apparatus of any of aspects 25 to 35, wherein the apparatus is a wireless communication device.

Aspect 37 is a method of communication for implementing any of aspects 25 to 35.

Aspect 38 is an apparatus for communication including means for implementing any of aspects 25 to 35.

Aspect 39 is a computer-readable medium (e.g., a non-transitory computer-readable medium) storing computer executable code (e.g., code for wireless communication), the code when executed by at least one processor causes the at least one processor to implement any of aspects 25 to 35.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
obtain an indication of a failure of a first handover process including a first candidate cell or a second handover process including a second candidate cell; and
perform a first recovery procedure for the failure of the first handover process or a second recovery procedure for the failure of the second handover process.

2. The apparatus of claim 1, wherein to perform the first recovery procedure for the failure of the first handover process, the at least one processor is configured to switch from the first handover process to the second handover process, and wherein to perform the second recovery procedure for the failure of the second handover process, the at least one processor is configured to switch from the second handover process to the first handover process.

3. The apparatus of claim 2, wherein the first handover process is a handover (HO) process, a conditional HO (CHO) process, or a conditional primary secondary cell (PScell) change (CPC) process, and wherein the second handover process is a lower layer triggered mobility (LTM) process or a conditional LTM (CLTM) process.

4. The apparatus of claim 1, wherein to obtain the indication of the failure of the first handover process including the first candidate cell or the second handover process including the second candidate cell, the at least one processor is configured to:
detect, at the UE, the failure of the first handover process including the first candidate cell or the second handover process including the second candidate cell.

5. The apparatus of claim 4, wherein to detect, at the UE, the failure of the first handover process including the first candidate cell or the second handover process including the second candidate cell, the at least one processor is configured to:
detect, based on an expiration of a timer at the UE, the failure of the first handover process including the first candidate cell or the second handover process including the second candidate cell.

6. The apparatus of claim 5, wherein the failure of the first handover process or the second handover process is a radio link failure (RLF).

7. The apparatus of claim 5, wherein the failure of the first handover process or the second handover process is a master cell group (MCG) failure or a secondary cell group (SCG) failure.

8. The apparatus of claim 5, wherein the timer is a T304 timer at the UE.

9. The apparatus of claim 1, wherein the at least one processor is further configured to:
select the first candidate cell for the first handover process or the second candidate cell for the second handover process.

10. The apparatus of claim 9, wherein to select the first candidate cell for the first handover process or the second candidate cell for the second handover process, the at least one processor is configured to:
select the first candidate cell for the first handover process or the second candidate cell for the second handover process; and
determine whether the first candidate cell is valid for the first handover process or whether the second candidate cell is valid for the second handover process.

11. The apparatus of claim 9, wherein to select the first candidate cell for the first handover process or the second candidate cell for the second handover process, the at least one processor is configured to:
select the first candidate cell from a set of first candidate cells for the first handover process or the second candidate cell from a set of second candidate cells for the second handover process.

12. The apparatus of claim 11, wherein the at least one processor is further configured to:
apply, prior to selection of the first candidate cell, a set of first weights to at least one first candidate cell in the set of first candidate cells; and
apply, prior to selection of the second candidate cell, a set of second weights to at least one second candidate cell in the set of second candidate cells.

13. The apparatus of claim 1, wherein the at least one processor is further configured to:
initiate, at the UE, performance of the first recovery procedure for the failure of the first handover process or the second recovery procedure for the failure of the second handover process.

14. The apparatus of claim 13, wherein to initiate the performance of the first recovery procedure or the second recovery procedure, the at least one processor is configured to:
initiate, prior to an expiration of a timer at the UE, the performance of the first recovery procedure or the second recovery procedure.

15. The apparatus of claim 14, wherein to initiate, prior to the expiration of the timer at the UE, the performance of the first recovery procedure or the second recovery procedure, the at least one processor is configured to:
initiate, prior to the expiration of the timer at the UE, the performance of the first recovery procedure or the second recovery procedure based on at least one of (1) data for a switch success/failure or (2) an artificial intelligence (AI) or machine learning (ML) (AI/ML) prediction of the expiration of the timer.

16. The apparatus of claim 1, wherein the at least one processor is further configured to:
receive, from a network node, an indication of a configuration for at least one of the first recovery procedure or the second recovery procedure, wherein the indication of the configuration includes at least one of a set of first recovery parameters for the first recovery procedure or a set of second recovery parameters for the second recovery procedure.

17. The apparatus of claim 1, wherein the at least one processor is further configured to:
transmit an indication of performance of the first recovery procedure for the failure of the first handover process or the second recovery procedure for the failure of the second handover process.

18. The apparatus of claim 17, wherein to transmit the indication of the performance of the first recovery procedure for the failure of the first handover process or the second recovery procedure for the failure of the second handover process, the at least one processor is configured to:
transmit, to a network node, a report of the performance of the first recovery procedure for the failure of the first handover process or the second recovery procedure for the failure of the second handover process.

19. A method of wireless communication at a user equipment (UE), comprising:
obtaining an indication of a failure of a first handover process including a first candidate cell or a second handover process including a second candidate cell; and
performing a first recovery procedure for the failure of the first handover process or a second recovery procedure for the failure of the second handover process.

20. An apparatus for wireless communication at a network node, comprising:
at least one memory; and
at least one processor coupled to the at least one memory and, based at least in part on information stored in the at least one memory, the at least one processor is configured to:
transmit, to a user equipment (UE), an indication of a configuration for at least one of a first recovery procedure for a failure of a first handover process including a first candidate cell and a second recovery procedure for a failure of a second handover process including a second candidate cell; and
receive, from the UE, an indication of a performance of the first recovery procedure for the failure of the first handover process or the second recovery procedure for the failure of the second handover process.
